(19) United States
(12) Patent Application Publication
(10) Pub. No.: US 2025/0354670 A1
(43) Pub. Date: Nov. 20, 2025

(54) METHODS, SYSTEMS, AND DEVICES FOR A SELECTABLE MULTICOLOR VEHICLE LIGHT

(71) Applicant: Toyota Motor North America, Inc., Plano, TX (US)

(72) Inventors: Tyler J. Kass, Hickory Creek, TX (US); James Andrew DeLong, Chandler, AZ (US); Adam Paul Boucher, Gilbert, AZ (US); Raymond Paul Chau, Phoenix, AZ (US); Ronald Steven Sutherland, Tempe, AZ (US); Monmohan Singh Brar, Phoenix, AZ (US)

(73) Assignees: Toyota Motor North America, Inc., Plano, TX (US); Toyota Jidosha Kabushiki Kaisha, Toyota-shi (JP)

(21) Appl. No.: 19/212,504

(22) Filed: May 19, 2025

Related U.S. Application Data
(60) Provisional application No. 63/649,130, filed on May 17, 2024.

(51) Int. Cl. F21S 41/125; B60Q 1/08; B60Q 1/20; F21S 41/143; F21V 23/00; F21V 23/04; F21W 102/30; F21Y 113/17; F21Y 115/10

(52) U.S. Cl. CPC F21S 41/125; B60Q 1/085; B60Q 1/20; F21S 41/143; F21V 23/005; F21V 23/0442; B60Q 2300/312; F21W 2102/30; F21Y 2113/17; F21Y 2115/10

(57) ABSTRACT

Methods, systems, and devices for a vehicle light. The vehicle light may include a housing and a substrate coupled to the housing. The vehicle light may further include a plurality of LEDs coupled to the substrate. The plurality of LEDs may include at least two LEDs of a first color and at least two LEDs of a second color. The plurality of LEDs may be positioned on the substrate such that a left half or portion of the substrate mirrors a right half or portion of the substrate and/or a top half or portion of the substrate mirrors a bottom half or portion of the substrate with respect to a position and a color of each LED of the plurality of LEDs.

### CROSS REFERENCE TO RELATED APPLICATIONS

This application claims the benefit and priority of U.S. Provisional Application Ser. No. 63/649,130, entitled “Methods, Systems, and Devices for a Selectable Multicolor Vehicle Light,” filed on May 17, 2024, the content of which is hereby incorporated by reference in its entirety herein.

### BACKGROUND

### 1. Field

The present disclosure relates to methods, systems, and/or devices for a selectable multicolor vehicle light.

### 2. Description of the Related Art

Vehicles may be equipped with one or more lights, such as headlights, fog lights, or accessory lights. These vehicle lights may utilize light emitting diodes (LEDs) to emit white light. White light may maximize a given light's output and visibility of objects or a road in a clear and unobstructed environment. However, white light can cause glare when operating in a foggy or obstructed environment due to, for example, diffraction of short wavelengths present in white light. Thus, in foggy or obstructed environments, other light colors may be preferable to white light. However, conventional vehicle lights, such as fog lights, are generally not able to emit light in a color besides white, and if they are able to emit more than one color of light, the conventional vehicle lights may exhibit a substantial beam shift when cycling between colors. This results in, for example, the conventional vehicle lights exhibiting poor performance due to uneven lighting and failing to meet various vehicle regulations or standards, such as Society of Automotive Engineers (SAE) lighting standards.

Accordingly, it is desirable to provide methods, systems, and devices for a selectable multicolor vehicle light.

### SUMMARY

In general, one aspect of the subject matter described in this disclosure may be embodied in a vehicle light (e.g., a vehicle front light). The vehicle light may include a housing. The vehicle light may further include a substrate coupled to the housing. The vehicle light may further include a plurality of LEDs coupled to the substrate. The plurality of LEDs may include at least two LEDs of a first color and at least two LEDs of a second color. The plurality of LEDs may be positioned on the substrate such that a left half or portion of the substrate mirrors a right half or portion of the substrate and/or a top half or portion of the substrate mirrors a bottom half or portion of the substrate with respect to a position and a color of each LED of the plurality of LEDs.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1A is a block diagram of an example vehicle for implementing a vehicle light according to an aspect of the disclosure.

FIG. 1B is a schematic front view of the vehicle and the vehicle light of FIG. 1 according to an aspect of the disclosure.

FIG. 2A is a schematic perspective view of the vehicle light of FIG. 1 according to an aspect of the disclosure.

FIG. 2B is a schematic top view of the vehicle light of FIG. 1 according to an aspect of the disclosure.

FIG. 3 is a schematic front view and top view of the vehicle light of FIG. 1 according to an aspect of the disclosure.

FIG. 4 is a chart illustrating example optical unit arrangements for the vehicle light of FIG. 1 according to an aspect of the disclosure.

FIGS. 5-11 are schematics illustrating examples of the optical arrangements of FIG. 4 according to aspects of the disclosure.

FIGS. 12-15 are graphs illustrating composite light beam patterns of the vehicle light of FIG. 1 according to aspects of the disclosure.

FIG. 16 is a flow diagram of an example process for controlling the vehicle light of FIG. 1 according to an aspect of the disclosure.

FIG. 17 and FIG. 18 are chromaticity diagrams illustrating bin ranges for selective yellow and white, respectively, according to aspects of the disclosure.

### DETAILED DESCRIPTION

Disclosed herein are methods, systems, devices, and/or vehicles for implementing a selectable multicolor vehicle light. The selectable multicolor vehicle light may include a plurality of optical units and a plurality of light emitting diodes (LEDs). Each optical unit of the plurality of optical units may include a projection lens, a reflector lens, or a combination of lens types and at least one LED of the plurality of LEDs in a first color and at least one LED of the plurality of LEDs in a second color. The plurality of optical units may be arranged such that the plurality of LEDs are symmetric about a vertical axis and/or a horizontal axis of the selectable multicolor vehicle light. Each of the plurality of first LEDs may be positioned directly adjacent to each of the plurality of second LEDs. Particular embodiments of the subject matter described in this disclosure may be implemented to realize one or more of the following advantages.

The selectable multicolor vehicle light may project light in the first color and the second color. The first color may be white and provides a sharp, focused beam for the driver to see far distances (i.e., greater than typical headlights and high beams) ahead of the vehicle. The second color may be selective yellow (Society of Automotive Engineers (SAE) defined) and improves visibility (e.g., by reducing glare) during difficult driving conditions, e.g., in foggy, rainy, snowy, or otherwise obstructed environments. In addition, the selectable multicolor vehicle light may exhibit minimal to no beam shift and/or change in beam pattern when cycling between the first color and the second color. Thus, the selectable multicolor vehicle light has the ability to meet U.S. regulations and/or SAE standards regarding vehicle light beam patterns (e.g., SAE J583) when projecting light in the first color and the second color. A processor on a printed circuit board may be used to cycle between the first color (i.e., the plurality of first LEDs) and the second color (e.g., the plurality of second LEDs), turn both sets of LEDs on simultaneously, and/or turn only one set of the plurality of LEDs at a time.

Moreover, in examples, the selectable multicolor vehicle light may automatically activate and/or cycle between the first color and the second color based on environmental conditions. For example, the selectable multicolor vehicle light may include one or more sensors that are configured to detect fog, rain, snow, and/or dust. The selectable multicolor vehicle light may automatically project the light in the second color (e.g., selective yellow) and/or control an intensity of the projected light when the one or more sensors detect the fog, rain, snow, and/or dust. The second color (e.g., selective yellow) may improve visibility during foggy or otherwise obstructed environments (e.g., by reducing glare).

Moreover, the selectable multicolor vehicle light may provide a user (e.g., a driver) a less distracting and more visually pleasing beam pattern since there is no beam shift and/or change in beam pattern when cycling between the first color and the second color. Thus, there is minimal to no change in an illuminated area when cycling between the first color and the second color thereby improving safety. The selectable multicolor vehicle light may also provide the user an opportunity for stylistic differentiation while keeping within vehicle lighting regulations and standards.

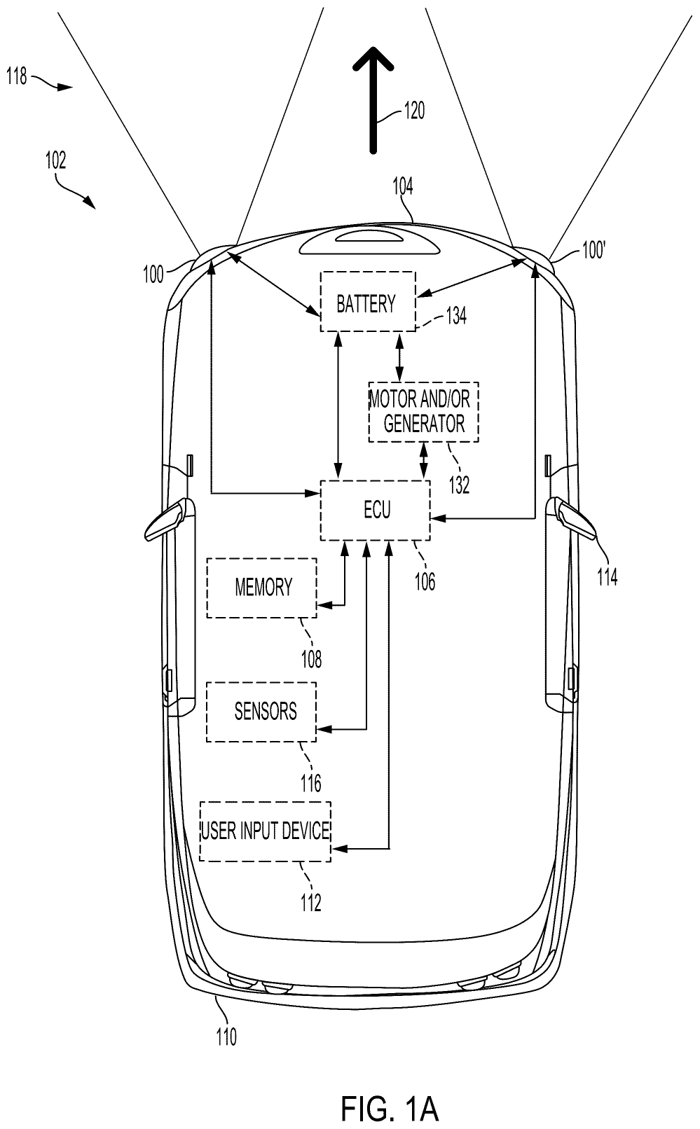

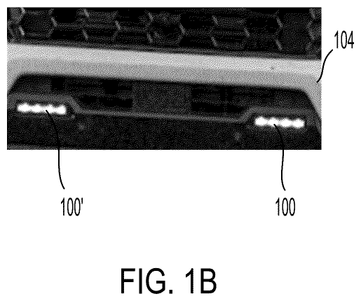

FIG. 1A is a block diagram of an example vehicle 102 for implementing a vehicle light 100 (also can be referred to as a multicolor vehicle fog light 100). The vehicle light 100 or a portion thereof may be retrofitted, coupled to, include, or be included within the vehicle 102 or separate from the vehicle 102. The vehicle light 100 may be coupled to a front bumper 104 of the vehicle 102, a rear bumper 110 of the vehicle 102, one or more mirrors 114 of the vehicle 102, and/or any other location on the vehicle 102. In examples, the vehicle light 100 may be coupled to an accessory that is coupled to the vehicle 102 (e.g., a light bar, a roof rack, etc.). In examples, the vehicle 102 may include a plurality of vehicle lights including, for example, the vehicle light 100 and another vehicle light 100′.

The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The vehicle 102 may include a motor and/or generator 132. The motor and/or generator 132 may be located within an engine bay of the vehicle 102. The motor and/or generator 132 may be an internal combustion engine (ICE). In this regard, the motor and/or generator 132 may combust an air and fuel mixture to provide power to the vehicle 102 and/or components of the vehicle 102 and/or the vehicle light 100. Accordingly, the motor and/or generator 132 can cause the vehicle 102 to accelerate, decelerate, or maintain a desired velocity. It should be understood that the motor and/or generator 132 may include combinations of an ICE and an electric motor, such as for hybrid vehicle applications for example. In examples, the motor and/or generator 132 may be an electric motor. In this regard, the motor and/or generator 132 may be an electric motor and an electric generator that converts electrical energy into mechanical power, such as torque, and converts mechanical power into electrical energy. The motor and/or generator 132 may be electrically connected to a battery 134. The motor and/or generator 132 may convert energy from the battery 134 into mechanical power, and may provide energy back to the battery 134, for example, via regenerative braking. The battery 134 may be electrically connected to the motor and/or generator 132 and may provide electrical energy to and/or receive electrical energy from the motor and/or generator 132. The battery 134 may provide electrical energy to the vehicle light 100.

The vehicle light 100 may project light 118 in a forward direction 120 with respect to the vehicle 102. In examples, the vehicle light 100 may project the light 118 in a rearward or other direction based on a mounting location of the vehicle light 100 on the vehicle 102. In examples, the vehicle light 100 may be adjustable such that an angle of the vehicle light 100 may be changed with respect to the vehicle 102. The vehicle light 100 may be, for example, a headlight, a taillight, a fog light, a daytime running light, an accent light, a turn signal, a spotlight, and/or an accessory light.

FIG. 1B illustrates the vehicle light 100 and another vehicle light 100′ coupled to the front bumper 104 of the vehicle 102.

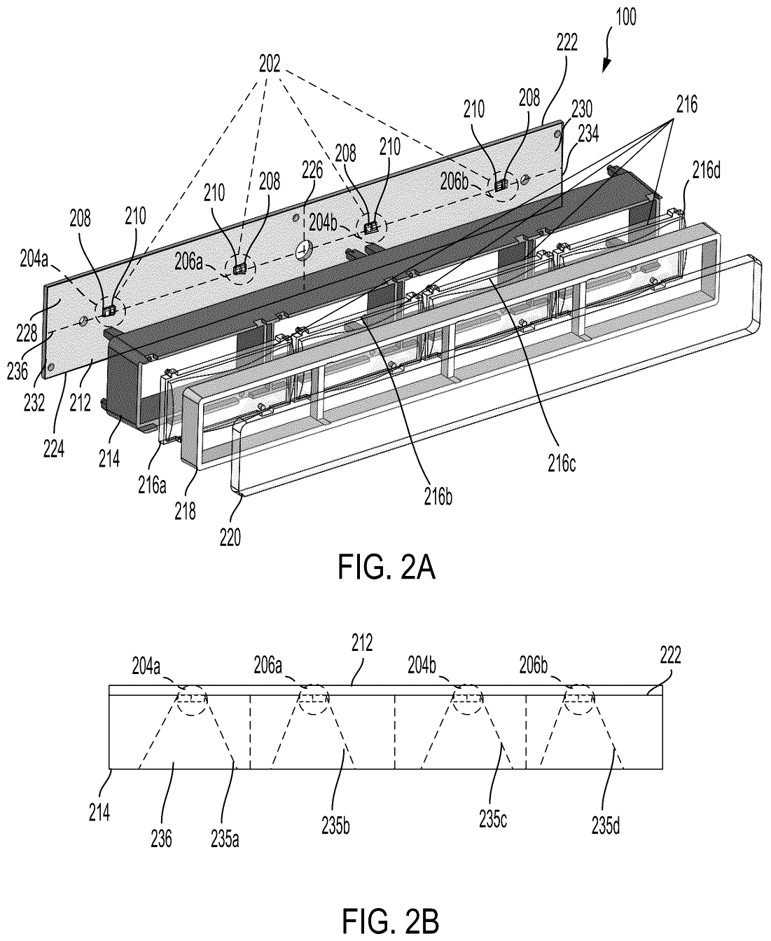

FIG. 2A is an exploded view of an example vehicle light 100. The vehicle light 100 may be configured to project the light 118 in a plurality of colors. For example, the vehicle light 100 may project the light 118 in white and selective yellow. In examples, the vehicle light 100 may project the light 118 in at least two of white, selective yellow, yellow, red, blue, green, purple, orange, and/or other colors. In examples, the vehicle light 100 may output between 20 lumens and 10,000 lumens.

The vehicle light 100 may include a housing 214, a substrate 212, a plurality of light emitting diodes (LEDs) 202, a plurality of projection lenses 216, a lens housing 218, and/or an outer lens 220.

The housing 214 may house and/or secure the plurality of LEDs 202, the plurality of projection lenses 216, the lens housing 218, and/or the outer lens 220. In examples, the housing 214 may provide a predetermined distance between the plurality of LEDs 202 and the plurality of projection lenses 216 in order to maximize an amount of the projected light 118 and/or to achieve a specific beam pattern of the projected light 118. In examples, the housing 214 may locate each of the plurality of projection lenses 216.

The substrate 212 may be coupled to the housing 214 and/or electrically connected to the plurality of LEDs 202. The substrate 212 may receive electrical energy from the vehicle 102 (e.g., via the battery 134 and/or the motor and/or generator 132) and may provide the electrical energy to the plurality of LEDs 202. In examples, the substrate 212 may be and/or include a rigid printed circuit board (PCB) and/or a flexible PCB with a processor, traces, electronics chips, and/or the plurality of LEDs 202 electrically connected to one another and mounted thereon. In examples, the substrate 212 may comprise a plurality of substrates.

The substrate 212 may have a top (or first) edge 222 and a bottom (or second) edge 224. The top edge 222 and the bottom edge 224 may define a height of the substrate 212. The substrate 212 may have a vertical (or first) axis 226 between the top edge 222 and the bottom edge 224. In examples, the vertical axis 226 may be a vertical centerline of the substrate 212. In examples, the vertical axis 226 may be parallel to but offset from a vertical centerline of the substrate 212. The vertical axis 226 may define a right (or first) half (or portion) 228 of the substrate 212 and a left (or second) half (or portion) 230 of the substrate 212 opposite the right half 228.

The substrate 212 may have a right (or third) edge 232 and a left (or fourth) edge 234. The vertical axis 226 may be parallel to the right edge 232 and/or the left edge 234. The right edge 232 and the left edge 234 may define a width of the substrate 212. The substrate 212 may have a horizontal (or second) axis 236 between the right edge 232 and the left edge 234. In examples, the horizontal axis 236 may be a horizontal centerline of the substrate 212. In examples, the horizontal axis 236 may be parallel to but offset from a horizontal centerline of the substrate 212. The horizontal axis 236 may define an upper (or top or third) half (or portion) of the substrate 212 and a lower (or bottom or fourth) half (or portion) of the substrate 212 opposite the upper half. The horizontal axis 236 may be parallel to the top edge 222 and/or the bottom edge 224.

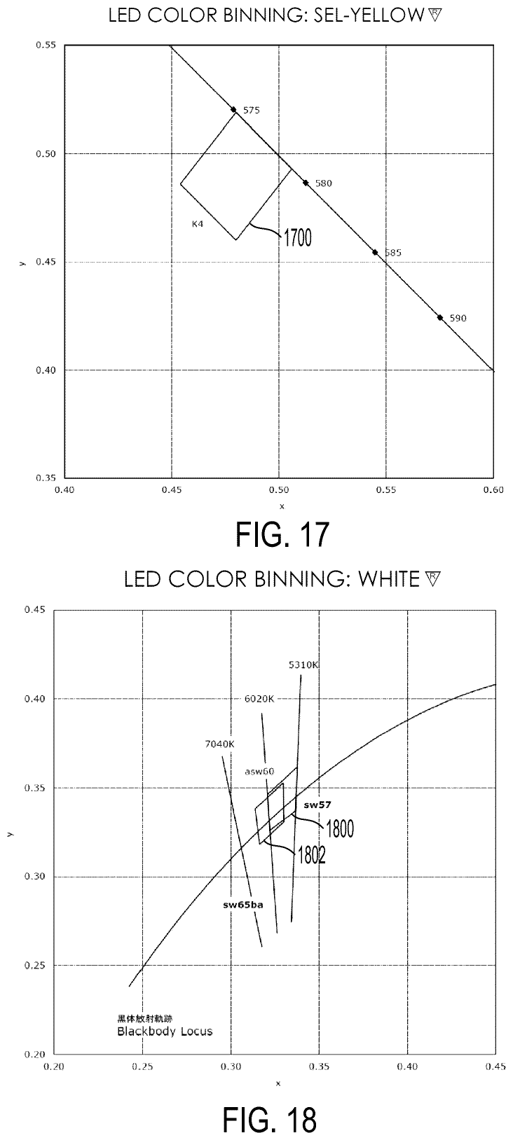

The plurality of LEDs 202 may be coupled to and/or electrically connected to the substrate 212. The plurality of LEDs 202 may include an equal number of LEDs in a first color 208 and a second color 210. In examples, the first color 208 may be white. In examples, the first color 208 may be white, selective yellow, yellow, red, blue, green, purple, orange, and/or other colors. In examples, the second color 210 may be selective yellow. In examples, the second color 210 may be white, selective yellow, yellow, red, blue, green, purple, orange, and/or other colors. In examples, selective yellow may be defined by SAE J578. Referring briefly to FIG. 17, in examples, selective yellow may be defined as being within bin 1700 (bin K4). Referring briefly to FIG. 18, in examples, white may be defined as being within bin 1800 (bin sw57) and/or bin 1802 (bin asw60).

Referring again to FIG. 2A, in examples, the plurality of LEDs 202 may be divided into groups of LEDs. For example, the plurality of LEDs 202 may include a first LED group 204a, a second LED group 206a, a third LED group 204b, and a fourth LED group 206b. In examples, the plurality of LEDs may include an even number of LED groups, such as two LED groups, four LED groups (e.g., as shown in FIG. 2A), six LED groups, or more. The LED groups 204a, 206a, 204b, and 206b may be evenly spaced apart on the substrate 212 or a plurality of substrates (e.g., each of the LED groups 204a, 206a, 204b, and 206b may be on a separate substrate). Each of the LED groups 204a, 206a, 204b, and 206b may include at least one LED in the first color 208 and at least one LED in the second color 210. The at least one LED in the first color 208 may be adjacent to the at least one LED in the second color 210.

The plurality of LEDs 202 may be distributed on the substrate 212 such that the right half 228 includes the same number of LEDs of the plurality of LEDs 202 as the left half 230. In examples, the plurality of LEDs 202 may be distributed on the substrate 212 such that the right half 228 includes the same number of LEDs in the first color 208 and the second color 210 as the left half 230. The plurality of LEDs 202 may be distributed on the substrate 212 such that a distribution of a first portion of the plurality of LEDs 202 on the right half 228 mirrors a distribution of a second portion of the plurality of LEDs 202 on the left half 230 (e.g., with respect to a color and a position of the plurality of LEDs 202). In examples, the plurality of LEDs 202 may be positioned along the horizontal axis 236 and/or mirrored about the horizontal centerline of the substrate 212.

In examples, the plurality of LEDs 202 may be distributed on the substrate 212 such that the upper half includes the same number of LEDs of the plurality of LEDs 202 as the lower half. In examples, the plurality of LEDs 202 may be distributed on the substrate 212 such that the upper half includes the same number of LEDs in the first color 208 and the second color 210 as the lower half. The plurality of LEDs 202 may be distributed on the substrate 212 such that a distribution of a third portion of the plurality of LEDs 202 on the upper half mirrors a distribution of a fourth portion of the plurality of LEDs 202 on the lower half (e.g., with respect to a color and a position of the plurality of LEDs 202). In examples, the plurality of LEDs 202 may be positioned along the vertical axis 226.

The plurality of projection lenses 216 may be coupled to the housing 214. The plurality of projection lenses 216 may be configured to focus the light 118 that is emitted from the plurality of LEDs 202 into one or more light beams. In examples, the plurality of projection lenses 216 may be and/or include a plurality of reflector lenses and/or a combination of lens types. In examples, the vehicle light 100 may include the same number of projection lenses and LED groups. For example, as shown in FIG. 2A, when the plurality of LEDs 202 include four LED groups 204a, 206a, 204b, and 206b the plurality of projection lenses 216 may include a first projection lens 216a, a second projection lens 216b, a third projection lens 216c, and a fourth projection lens 216d. The plurality of projection lenses 216 and the plurality of LEDs 202 may be positioned such that each of the plurality of projection lenses 216 focuses light emitted from one LED group of the LED groups 204a, 206a, 204b, and 206b. In examples, the plurality of projection lenses 216 may be made of glass and/or a plastic material (e.g., polycarbonate, acrylic, polymethyl methacrylate, etc.).

The lens housing 218 may be coupled to the housing 214. In examples, the lens housing 218 may include one or more tabs to removably coupled to the housing 214. The lens housing 218 may locate and/or secure each of the plurality of projection lenses 216. In examples, the lens housing 218 may locate and/or secure the outer lens 220.

The outer lens 220 may be coupled to the housing 214 and/or the lens housing 218. The outer lens 220 may seal at least a portion of the vehicle light 100 from moisture and/or dust. In examples, the outer lens 220 may be made of glass and/or a plastic material (e.g., polycarbonate, acrylic, polymethyl methacrylate, etc.).

FIG. 2B is a schematic top view of the vehicle light 100 with portions of the vehicle light 100 not shown to better illustrate certain features of the vehicle light 100, in examples. In examples, the vehicle light 100 may further include one or more reflectors (or lens reflectors). The one or more reflectors may include a first reflector 235a, a second reflector 235b, a third reflector 235c, and/or a fourth reflector 235d. The one or more reflectors 235a, 235b, 235c, and 235d may be coupled to the substrate 212, the housing 214, and/or the plurality of projection lenses 216. The one or more reflectors 235a, 235b, 235c, and 235d may be configured to focus light from the plurality of LEDs 202 toward the plurality of projection lenses 216 and/or to produce a tighter (e.g., a narrower, more focused) beam pattern. In examples, the one or more reflectors 235a, 235b, 235c, and 235d may be positioned between the substrate 212 and the plurality of projection lenses 216. In examples, the one or more reflectors 235a, 235b, 235c, and 235d may each be positioned within a tunnel 236 formed by the housing 214. In examples, the housing 214 may include a plurality of tunnels, with each of the LED groups 204a, 206a, 204b, and 206b being positioned within a tunnel of the plurality of tunnels. The plurality of tunnels, such as the tunnel 236, may ensure that light from each of the LED groups 204a, 206a, 204b, and 206b passes through a single projection lens of the plurality of projection lenses 216. This may improve a beam pattern of the vehicle light 100 and/or thermal performance (e.g., heat distribution) of the vehicle light 100. In examples, the one or more reflectors 235a, 235b, 235c, and 235d may each be cone shaped and/or rectangular to fit within a rectangular shape of each of the plurality of tunnels.

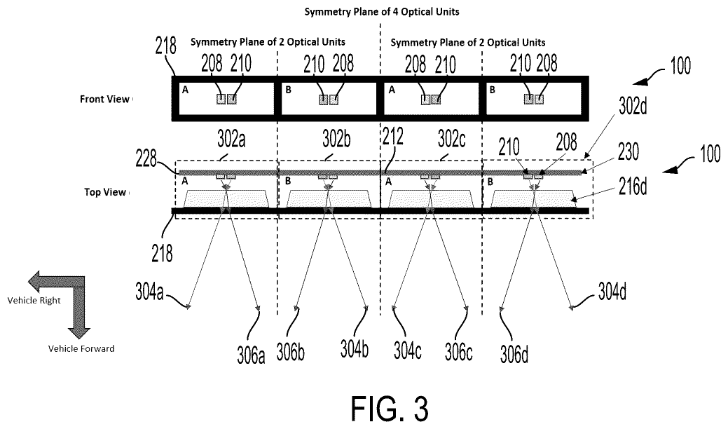

FIG. 3 illustrates a front view of the vehicle light 100 and a top view of the vehicle light 100 with portions of the vehicle light 100 not shown to better illustrate certain features of the vehicle light 100. With reference to FIG. 3 and continuing reference to FIG. 2A, the vehicle light 100 may include a plurality of optical (or light) units. The plurality of optical units may include a first optical unit 302a, a second optical unit 302b, a third optical unit 302c, and/or a fourth optical unit 302d. In examples, the vehicle light 100 may include two optical units or may include six or eight optical units. Each optical unit of the plurality of optical units 302a, 302b, 302c, and 302d may include two or more LEDs of the plurality of LEDs 202 and one projection lens of the plurality of projection lenses 216. In examples, each optical unit of the plurality of optical units 302a, 302b, 302c, and 302d may include one LED group 204a, 206a, 204b, or 206b and one projection lens of the plurality of projection lenses 216. Each LED group 204a, 206a, 204b, or 206b may be positioned in a focal window of a given projection lens of a given optical unit. The plurality of optical units 302a, 302b, 302c, and 302d may each include at least one LED in the first color 208 and at least one LED in the second color 210.

By having each of the plurality of optical units 302a, 302b, 302c, and 302d project the light 118 in the first color 208 and the second color 210 instead of having separate optical units for the first color 208 and the second color 210, the vehicle light 100 has increased thermal performance and output can be increased due to thermal load distribution and optical load distribution between the plurality of projection lenses 216 and on the substrate 212. Moreover, a size of the vehicle light 100 may be reduced as a function of the improved thermal distribution, allowing for more uniform thermal conduction from the plurality of LEDs 202 and the substrate 212 to one or more heatsinks (not shown), such that a size of the one or more heatsinks may be optimized and reduced. In addition, aesthetics of the vehicle light 100 are improved because during operation, each of the plurality of optical units 302a, 302b, 302c, and 302d project light such that the vehicle light 100 does not have the appearance of having malfunctioning optical units. Moreover, the vehicle light 100 may utilize less parts and specialized tooling by not requiring a uniquely shaped and/or colored projection lens for the first color 208 and the second color 210.

When the vehicle light 100 includes, for example, two optical units, one optical unit may be positioned on the right side 228 and one optical unit may be positioned on the left side 230, with the one optical unit on the left side 230 mirroring the one optical unit on the right side 228. In examples, when the vehicle light 100 includes two optical units, one optical unit may be positioned on the upper half and one optical unit may be positioned on the lower half, with the one optical unit on the lower half mirroring the one optical unit on the upper half.

When the vehicle light 100 includes, for example, four optical units, two optical units may be positioned on the right side 228 and two optical units may be positioned on the left side 230, with the two optical units on the left side 230 mirroring the two optical units on the right side 228. Thus, when the vehicle light 100 includes four optical units, the first optical unit 302a may have the same number and orientation of LEDs of the plurality of LEDs 202 (e.g., one LED in the first color 208 adjacent to and to the right of one LED in the second color 210) as the third optical unit 302c, and the second optical unit 302b may have the same number and orientation of LEDs of the plurality of LEDs 202 (e.g., one LED in the first color 208 adjacent to and to the left of one LED in the second color 210) as the fourth optical unit 302d. In examples, when the vehicle light 100 includes, four optical units, two optical units may be positioned on the upper half and two optical units may be positioned on the lower half, with the two optical units on the lower half mirroring the two optical units on the upper half.

Therefore, in examples, regardless of whether the vehicle light 100 includes two, four, six, or more optical units, each optical unit may have one of two LED orientations such as, for example, “A” or “B”. In examples, the “A” LED orientation may be the mirror of the “B” LED orientation (e.g., with respect to a quantity and positioning of LEDs in the first color 208 and in the second color 210). For example, as illustrated in FIG. 3, when the vehicle light 100 includes four optical units, the first and third optical units 302a and 302c may have the “A” LED orientation and the second and fourth optical units 302b and 302d may have the “B” LED orientation, or visa versa. In examples where the vehicle light 100 includes only two optical units, the two optical units may include one optical unit having the “A” LED orientation and one optical unit having the “B” LED orientation. Thus, in examples, each optical unit within the vehicle light 100 may have an LED orientation that is the mirror of an LED orientation of an adjacent (or neighboring) optical unit.

In examples, at least a portion of the plurality of LEDs 202 may be angled or tilted away from a mounting surface of the substrate 212 (e.g., toward a center of the substrate 212, the right edge 228, the left edge 230, the top edge 222 and/or the bottom edge 224) to compensate for differences in focal position of the plurality of LEDs 202 and/or to produce specific beam patterns.

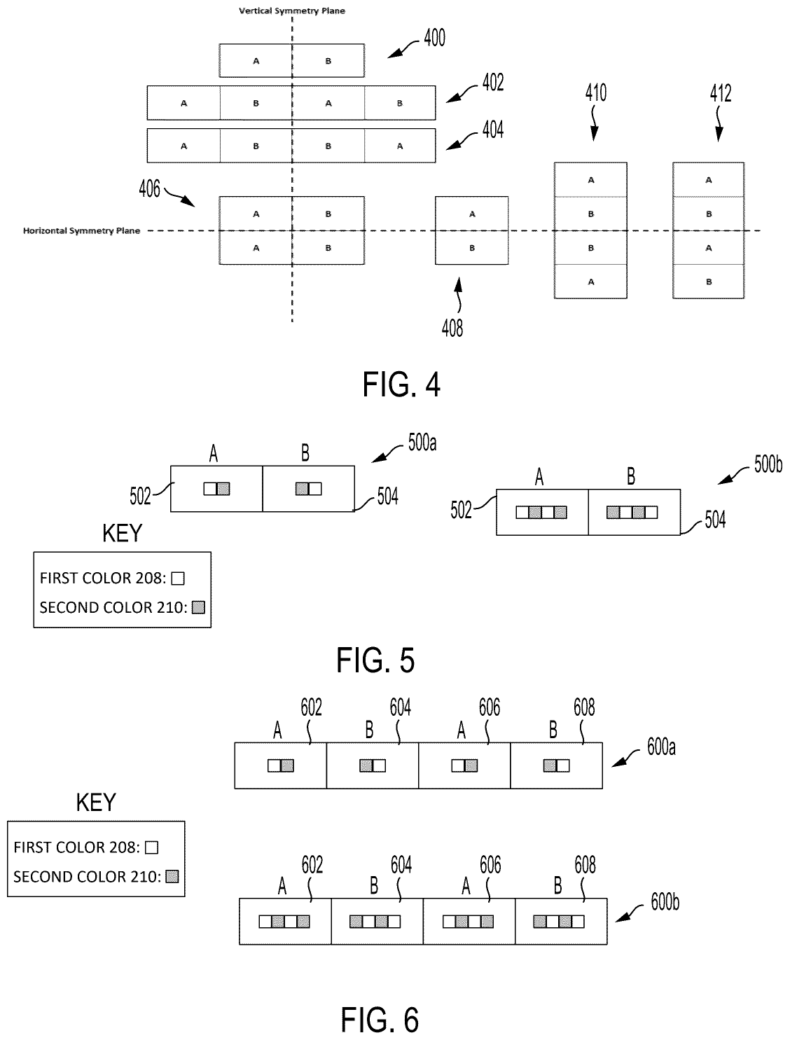

Referencing FIG. 4 with continued reference to FIG. 2A and FIG. 3, FIG. 4 illustrates a front view of example arrangements of optical units each having an “A” LED orientation or a “B” LED orientation, with the optical unit arrangements having a vertical symmetry plane and/or a horizontal symmetry plane. FIG. 4 illustrates a first optical unit arrangement 400, a second optical unit arrangement 402, a third optical unit arrangement 404, a fourth optical unit arrangement 406, a fifth optical unit arrangement 408, a sixth optical unit arrangement 410, and a seventh optical unit arrangement 412. In examples, the optical units of the vehicle light 100 may be arranged differently than shown in FIG. 4. The “A” and “B” LED orientations illustrated in FIG. 4 may each include any distribution of a portion of the plurality of LEDs 202 that results in the given optical unit arrangement 400, 402, 404, 406, 408, 410, and 412 having the vertical symmetry plane and/or the horizontal symmetry plane.

FIGS. 5-11 illustrate example distributions of the plurality of LEDs 202 for each of the optical unit arrangements 400, 402, 404, 406, 408, 410, and 412. Referencing FIG. 5 with continued reference to FIGS. 2-4, in the first optical unit arrangement 400, the vehicle light 100 may include a first optical unit 502 and a second optical unit 504, with the first and second optical units 502 and 504 being positioned along a horizontal axis. The first optical unit 502 may be adjacent to the second optical unit 504. The first optical unit 502 may have an “A” LED orientation and the second optical unit 504 may have a “B” LED orientation (or visa versa). FIG. 5 illustrates two examples of the “A” LED orientation and the “B” LED orientation for the first optical unit arrangement 400 (although not all are shown, more examples of the first optical unit arrangement 400 are possible). In a first example 500a of the first optical unit arrangement 400, the “A” and “B” LED orientations may each include one LED in the first color 208 adjacent to one LED in the second color 210 arranged as shown in FIG. 5 (or visa versa). In a second example 500b of the first optical unit arrangement 400, the “A” and “B” LED orientations may each include two LEDs in the first color 208 and two LEDs in the second color 210 arranged as shown in FIG. 5 (or visa versa).

Referencing FIG. 6 with continued reference to FIGS. 2-4, in the second optical unit arrangement 402, the vehicle light 100 may include a first optical unit 602, a second optical unit 604, a third optical unit 606, and a fourth optical unit 608, with the optical units 602, 604, 606, and 608 being positioned along a horizontal axis. The first and third optical units 602 and 606 may have an “A” LED orientation and the second and fourth optical units 604 and 608 may have a “B” LED orientation (or visa versa). FIG. 6 illustrates two examples of the “A” LED orientation and the “B” LED orientation for the second optical unit arrangement 402 (although not all are shown, more examples of the second optical unit arrangement 402 are possible). In a first example 600a of the second optical unit arrangement 402, the “A” and “B” LED orientations may each include one LED in the first color 208 adjacent to one LED in the second color 210 arranged as shown in FIG. 6 (or visa versa). In a second example 600b of the second optical unit arrangement 402, the “A” and “B” LED orientations may each include two LEDs in the first color 208 and two LEDs in the second color 210 arranged as shown in FIG. 6 (or visa versa).

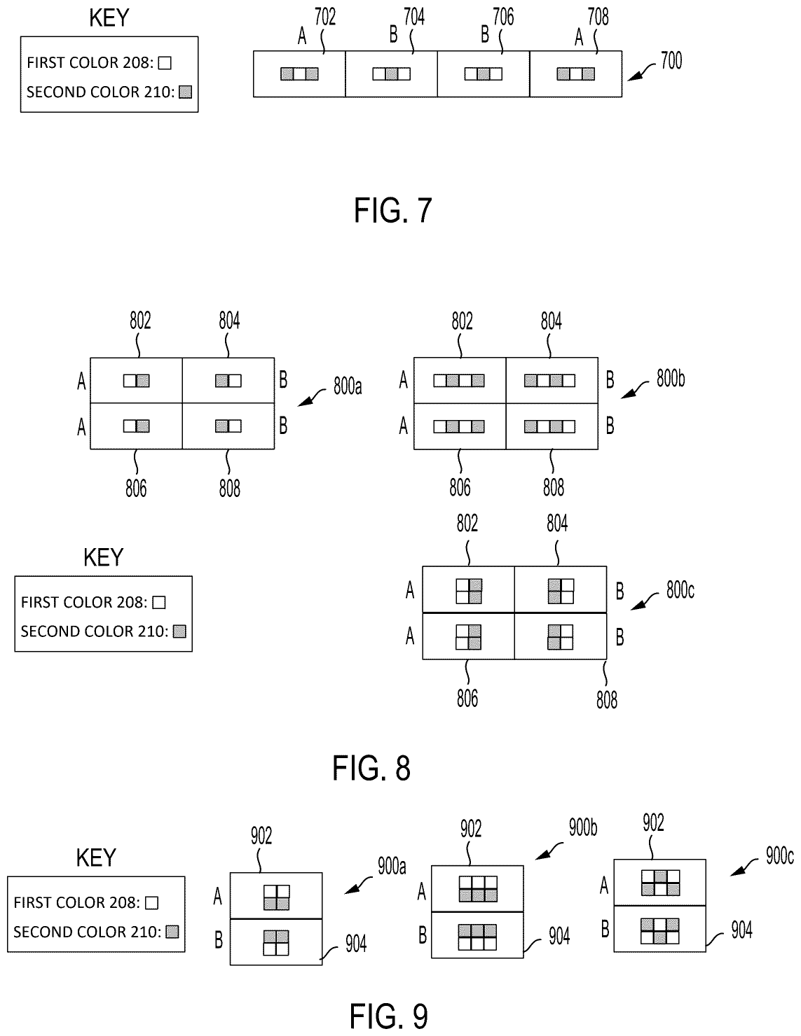

Referencing FIG. 7 with continued reference to FIGS. 2-4, in the third optical unit arrangement 404, the vehicle light 100 may include a first optical unit 702, a second optical unit 704, a third optical unit 706, and a fourth optical unit 708, with the optical units 702, 704, 706, and 708 being positioned along a horizontal axis. The first and third optical units 702 and 706 may have an “A” LED orientation and the second and fourth optical units 704 and 708 may have a “B” LED orientation (or visa versa). FIG. 7 illustrates one example of the “A” LED orientation and the “B” LED orientation for the third optical unit arrangement 404 (although not all are shown, more examples of the third optical unit arrangement 404 are possible). In an example 700 of the third optical unit arrangement 404, the “A” LED orientation may include one LED in the first color 208 adjacent to two LEDs in the second color 210 arranged as shown in FIG. 7 and the “B” LED orientation may include two LEDs in the first color 208 and one LED in the second color 210 arranged as shown in FIG. 7 (or visa versa).

Referencing FIG. 8 with continued reference to FIGS. 2-4, in the fourth optical unit arrangement 406, the vehicle light 100 may include a first optical unit 802, a second optical unit 804, a third optical unit 806, and a fourth optical unit 808, with the first and second optical units 802 and 804 being positioned along a first horizontal axis and the third and fourth optical units 806 and 808 being positioned along a second horizontal axis below the first and second optical units 802 and 804. The first and third optical units 802 and 806 may have an “A” LED orientation and the second and fourth optical units 804 and 808 may have a “B” LED orientation (or visa versa). FIG. 8 illustrates three examples of the “A” LED orientation and the “B” LED orientation for the fourth optical unit arrangement 406 (although not all are shown, more examples of the fourth optical unit arrangement 406 are possible). In a first example 800a of the fourth optical unit arrangement 406, the “A” and “B” LED orientations may each include one LED in the first color 208 adjacent to one LED in the second color 210 arranged as shown in FIG. 8 (or visa versa). In a second example 800b of the fourth optical unit arrangement 406, the “A” and “B” LED orientations may each include two LEDs in the first color 208 and two LEDs in the second color 210 arranged as shown in FIG. 8 (or visa versa). In a third example 800c of the fourth optical unit arrangement 406, the “A” and “B” LED orientations may each include two LEDs in the first color 208 and two LEDs in the second color 210 arranged as shown in FIG. 8 (or visa versa).

Referencing FIG. 9 with continued reference to FIGS. 2-4, in the fifth optical unit arrangement 408, the vehicle light 100 may include a first optical unit 902 and a second optical unit 904, with the first and second optical units 902 and 904 being positioned along a vertical axis. The first optical unit 902 may be on top of the second optical unit 904. The first optical unit 902 may have an “A” LED orientation and the second optical unit 904 may have a “B” LED orientation (or visa versa). FIG. 9 illustrates three examples of the “A” LED orientation and the “B” LED orientation for the fifth optical unit arrangement 408 (although not all are shown, more examples of the fifth optical unit arrangement 408 are possible). In a first example 900a of the fifth optical unit arrangement 408, the “A” and “B” LED orientations may each include two LEDs in the first color 208 on top of two LEDs in the second color 210 arranged as shown in FIG. 9 (or visa versa). In a second example 900b of the fifth optical unit arrangement 408, the “A” and “B” LED orientations may each include three LEDs in the first color 208 on top of three LEDs in the second color 210 arranged as shown in FIG. 9 (or visa versa). In a third example 900c of the fifth optical unit arrangement 408, the “A” and “B” LED orientations may each include three LEDs in the first color 208 and three LEDs in the second color 210 arranged as shown in FIG. 9 (or visa versa).

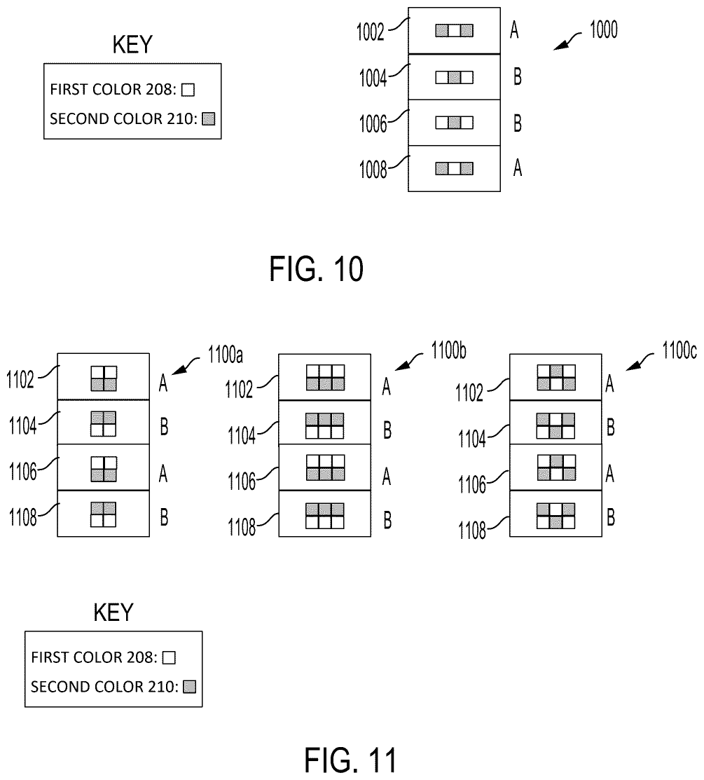

Referencing FIG. 10 with continued reference to FIGS. 2-4, in the sixth optical unit arrangement 410, the vehicle light 100 may include a first optical unit 1002, a second optical unit 1004, a third optical unit 1006, and a fourth optical unit 1008, with the optical units 1002, 1004, 1006, and 1008 being positioned along a vertical axis. The first and fourth optical units 1002 and 1008 may have an “A” LED orientation and the second and third optical units 1004 and 1006 may have a “B” LED orientation (or visa versa). FIG. 10 illustrates one example of the “A” LED orientation and the “B” LED orientation for the sixth optical unit arrangement 410 (although not all are shown, more examples of the sixth optical unit arrangement 410 are possible). In an example 1000 of the sixth optical unit arrangement 410, the “A” LED orientation may include one LED in the first color 208 adjacent to two LEDs in the second color 210 arranged as shown in FIG. 10 and the “B” LED orientation may include two LEDs in the first color 208 and one LED in the second color 210 arranged as shown in FIG. 10 (or visa versa).

Referencing FIG. 11 with continued reference to FIGS. 2-4, in the seventh optical unit arrangement 412, the vehicle light 100 may include a first optical unit 1102, a second optical unit 1104, a third optical unit 1106, and a fourth optical unit 1108, with the optical units 1102, 1104, 1106, and 1108 being positioned along a vertical axis. The first and third optical units 1102 and 1106 may have an “A” LED orientation and the second and fourth optical units 1104 and 1108 may have a “B” LED orientation (or visa versa). FIG. 11 illustrates three examples of the “A” LED orientation and the “B” LED orientation for the seventh optical unit arrangement 412 (although not all are shown, more examples of the seventh optical unit arrangement 412 are possible). In a first example 1100a of the seventh optical unit arrangement 412, the “A” LED orientation may include two LEDs in the first color 208 on top of two LEDs in the second color 210 arranged as shown in FIG. 11 and the “B” LED orientation may include two LEDs in the second color 210 on top of two LEDs in the first color 208 arranged as shown in FIG. 11 (or visa versa). In a second example 1100b of the seventh optical unit arrangement 412, the “A” LED orientation may include three LEDs in the first color 208 on top of three LEDs in the second color 210 arranged as shown in FIG. 11 and the “B” LED orientation may include three LEDs in the second color 210 on top of three LEDs in the first color 208 arranged as shown in FIG. 11 (or visa versa). In a third example 1100c of the seventh optical unit arrangement 412, the “A” LED orientation may include three LEDs in the first color 208 and three LEDs in the second color 210 arranged as shown in FIG. 11 and the “B” LED orientation may include three LEDs in the second color 210 and three LEDs in the first color 208 arranged as shown in FIG. 11 (or visa versa).

Referring again to FIG. 3 with continuing reference to FIG. 2A, as discussed above, the vehicle light 100 includes the plurality of LEDs 202 with a first portion of the plurality of LEDs 202 being in the first color 208 and a second portion of the plurality of LEDs 202 being in the second color 210. This enables the vehicle light 100 to project the light 118 in the first color 208 and the second color 210. Conventionally, an LED light that is able to cycle between two colors results in substantial beam shift between the two colors because two LEDs cannot occupy the same focal point of a projection lens. For example, a light having one optical unit (e.g., the first optical unit 302a) would project a beam 306a in the first color 208 and a beam 304a in the second color 210, or visa versa. The substantial beam shift between the beams 304a and 306a may not only be inconvenient and distracting to a user (e.g., a driver of the vehicle 102), but may also not meet certain vehicle regulations or standards, such as Society of Automotive Engineers (SAE) standards, for fog lights, headlights, and/or other vehicle lights.

However, the vehicle light 100 may cycle between colors while being compliant with SAE standards and other vehicle regulations (e.g., SAE standards regarding fog light beam patterns). By having symmetry between two halves (or sides) of the substrate 212 and/or of the vehicle light 100 (e.g., left and right and/or top and bottom) with respect to the number, positioning, and LED orientation of the plurality of optical units 302a, 302b, 302c, and 302d, the vehicle light 100 may switch between projecting the light 118 in the first color 208 and the second color 210 with minimal or no beam shift between the first color 208 and the second color 210. The symmetry of the plurality of optical units 302a, 302b, 302c, and 302d compensates for the beam skew or misalignment of each individual optical unit by overlapping beams of neighboring optical units.

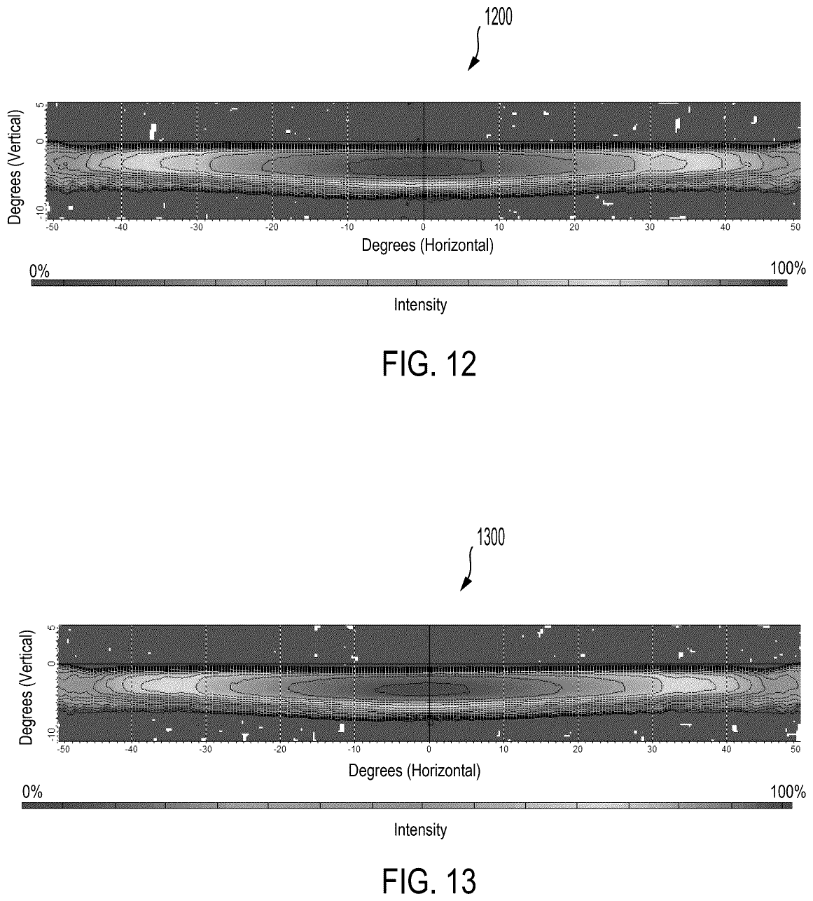

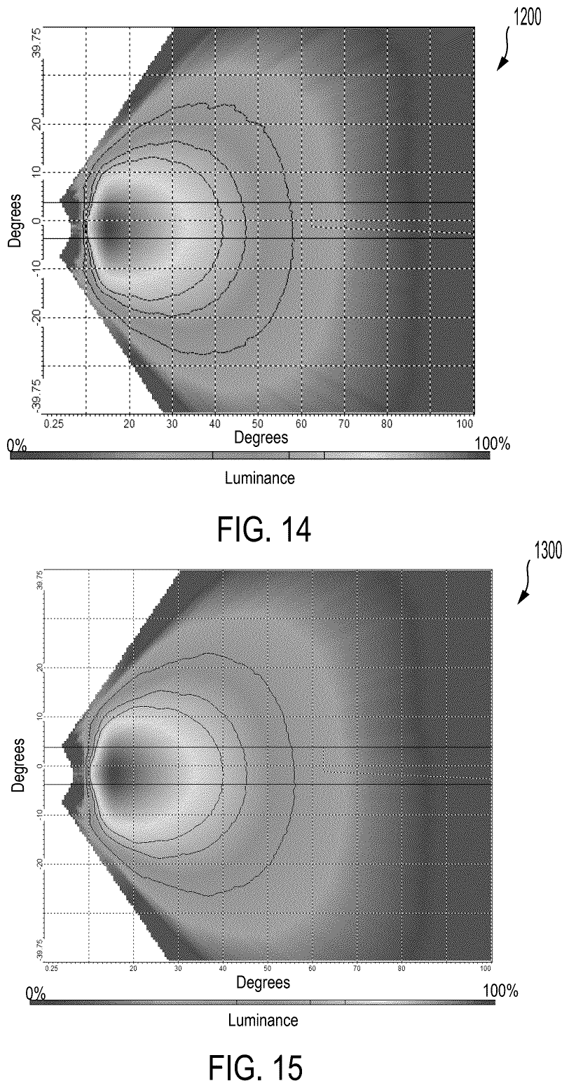

For example, as shown by FIG. 12 and FIG. 14, when the vehicle light 100 projects the light 118 in the first color 208, beams 306a, 306b, 306c, and 308d emitted by the plurality of optical units 302a, 302b, 302c, and 302d form a first composite beam 1200 (FIG. 12 illustrates a forward view of a beam pattern of the first composite beam 1200 and FIG. 14 illustrates a top down view of the beam pattern of the first composite beam 1200). And, as shown by FIG. 13 and FIG. 15, when the vehicle light 100 projects the light 118 in the second color 210, beams 304a, 304b, 304c, and 304d emitted by the plurality of optical units 302a, 302b, 302c, and 302d form a second composite beam 1300 (FIG. 13 illustrates a forward view of a beam pattern of the second composite beam 1300 and FIG. 15 illustrates a top down view of the beam pattern of the second composite beam 1300). When viewed in the far-field (e.g., road surface distances from the vehicle 102), the first composite beam 1200 and the second composite beam 1300 are each single homogeneous beams presenting no net shift left or right from a center of the vehicle light 100.

As shown in FIGS. 12-15, there is minimal to no beam shift when the vehicle light 100 cycles between projecting the light 118 in the first color 208 and in the second color 210. In examples, a difference may exist in intensity curve positions between the first color 208 and the second color 210 due to certain colors of LEDs having lower or higher overall output due to LED design parameters. While this is a change in relative intensity, the net beam patterns of the first color 208 and the second color 210 are still the same.

Turning again to FIG. 1, the vehicle light 100 and/or the vehicle 102 may further include one or more sensors 116. The one or more sensors 116 may be coupled to the front bumper 104 and/or a windshield of the vehicle 102 and/or may be located on or within the vehicle 102 or the vehicle light 100. The one or more sensors 116 may be configured to determine, measure, and/or detect an amount and/or a density of rain, fog, snow, and/or dust in a surrounding environment (or area) of the vehicle 102. The one or more sensors 116 may include an ambient light sensor, a camera, a humidity sensor, a dust sensor, and/or one or more additional sensors configured to detect rain, fog, snow, dust, and/or a visibility level of the surrounding environment of the vehicle 102.

The vehicle light 100 and/or the vehicle 102 may further include a user input device 112. The user input device 112 may be coupled to the vehicle light 100 and/or a dashboard of the vehicle 102 and/or may be located within a cabin of the vehicle 102. The user input device 112 may be and/or include one or more buttons, one or more switches, one or more dials, one or more touch screens, one or more gesture control sensors, one or more voice control sensors, and/or any other input devices. The user input device 112 may receive and/or detect user input from a user (e.g., a driver and/or a passenger of the vehicle 102) to activate or deactivate the vehicle light 100 and to cycle between the first color 208 and the second color 210.

The vehicle light 100 and/or the vehicle 102 may further include one or more processors, such as an electronic control unit (ECU) 106. The ECU 106 may be implemented as a single ECU or in multiple ECUs. The ECU 106 may be electrically connected to some or all of the components of the vehicle 102 and/or the vehicle light 100. The ECU 106 may be electrically connected to the motor and/or generator 132, the battery 134, the vehicle light 100, the one or more sensors 116, the user input device 112, and/or a memory 108. The ECU 106 may include one or more processors (or controllers) specifically designed for controlling operations of the vehicle 102.

The vehicle light 100 and/or the vehicle 102 may further include the memory 108. The memory 108 may be electrically connected to the ECU 106. In examples, the memory 108 may be communicatively coupled (e.g., via a network) to the ECU 106 such that the memory 108 is remote from the ECU 106 and/or the vehicle 102. In other examples, the memory 108 may be electrically connected to the ECU 106 and a remote memory may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle parameters (e.g., vehicle weight, transmission gear information, etc.).

In examples, the vehicle light 100 may be configured to be controlled via the user input device 112. That is, a user may manually control the vehicle light 100 to activate or deactivate, and to cycle between projecting the light 118 in the first color 208 and the second color 210. In examples, the user may control the vehicle light 100 to project the light 118 in the first color 208 and the second color 210 simultaneously to better illuminate the surrounding area of the vehicle 100. Since the vehicle light 100 does not exhibit beam shift between the first color 208 and the second color 210, the vehicle light 100 projects a homogenous beam pattern when the first color 208 and the second color 210 are projected simultaneously.

In examples, the vehicle light 100 may be configured to be controlled via automatically via the one or more sensors 116 and the ECU 106. For example, the ECU 106 may be configured to receive an indication from the one or more sensors 116 when a current level of rain, fog, snow, and/or dust in the surrounding area of the vehicle 102 is greater than or equal to the predetermined threshold. In examples, the ECU 106 may be configured to receive an indication from the one or more sensors 116 when a current visibility level of the surrounding area of the vehicle 102 is less than or equal to a visibility threshold. The ECU 106 may be further configured to activate the vehicle light 100 to project the light 118 in the second color 210 or to cycle the vehicle light 100 from projecting the light 118 in the first color 208 to projecting the light 118 in the second color 210 based on the received indication. In examples, the predetermined threshold with respect to rain, fog, snow, and/or dust and/or the visibility threshold may be stored on the memory 108.

In examples, the ECU 106 may be configured to control a quantity of the plurality of LEDs 202 that are activated based on a detected visibility level. For example, the ECU 106 may receive a detected visibility level from the one or more sensors 116. The ECU 106 may determine a light intensity based on the received detected visibility level. In examples, the determined light intensity may be greater when the detected visibility level is high and may be lower when the detected visibility level is low so as to not produce glare and/or blind the driver with light reflecting off fog, rain, snow, and/or dust. The ECU 106 may dim the vehicle light 100 and/or may deactivate two or more optical units of the vehicle light 100 based on the determined light intensity. For example, when the vehicle light 100 includes four optical units 302a, 302b, 302c, and 302d, the ECU 106 may control the vehicle light 100 to project the light 118 via the first optical unit 302a and the second optical unit 302b, the third optical unit 302c and the fourth optical unit 302d, the first optical unit 302a and the fourth optical unit 302d, or the second optical unit 302b and the third optical unit 302c. That is, the ECU 106 controls the vehicle light 100 by activating optical units that are mirrored. This ensures that a beam pattern of the vehicle light 100 stays homogeneous and does not exhibit beam shift even when some optical units of the vehicle light 100 are not projecting a portion of the light 118.

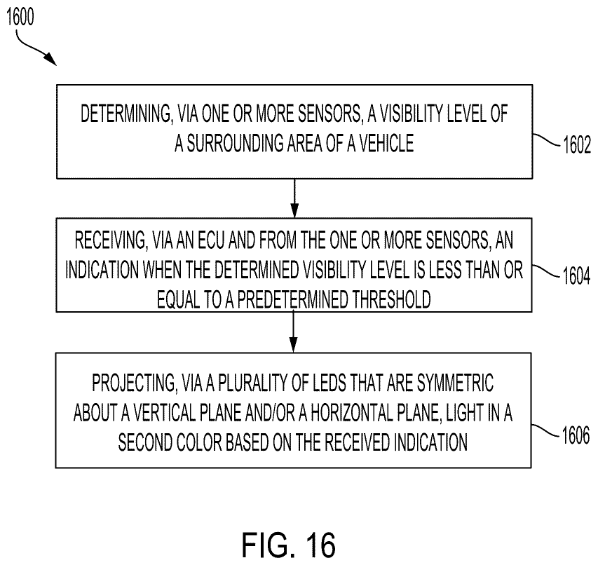

FIG. 16 is a flow diagram of an example process 1600 for controlling the vehicle light 100. One or more computers or one or more data processing apparatuses, for example, the ECU 106, appropriately programmed, may implement the process 1600. For ease of description, the process 1600 is described below with reference to FIGS. 1-15. The process 1600 of the present disclosure, however, is not limited to use of the exemplary vehicle lights of FIGS. 1-15.

The vehicle light 100 may determine, via the one or more sensors 116, a visibility level of a surrounding area of the vehicle 102 (1602). The visibility level may indicate an amount and/or density of rain, fog, snow, and/or dust in the surrounding area of the vehicle 102. In examples, the vehicle light 100 may project the light 118 in the first color 208 when the determined visibility level is not equal to or less than a predetermined threshold.

The vehicle light 100 may receive, via the ECU 106 and from the one or more sensors 116, an indication when the determined visibility level is less than or equal to a predetermined threshold (1604). In examples, the ECU 106 may receive the determined visibility level from the one or more sensors 116 and may compare the determined visibility level to the predetermined threshold.

The vehicle light 100 may project, via the plurality of LEDs 202 that are symmetric about the vertical plane and/or the horizontal plane, the light 118 in the second color 210 based on the received indication (1606). In examples, the ECU 106 may activate the vehicle light 100 based on the received indication. In examples, the ECU 106 may cycle the vehicle light 100 from the first color 208 to the second color 210 based on the received indication.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A vehicle light comprising:
a housing;
a substrate coupled to the housing; and
a plurality of light emitting diodes (LEDs) coupled to the substrate and including at least two LEDs of a first color and at least two LEDs of a second color, the plurality of LEDs being positioned on the substrate such that a left half or portion of the substrate mirrors a right half or portion of the substrate and a top half or portion of the substrate mirrors a bottom half or portion of the substrate with respect to a position and a color of each LED of the plurality of LEDs.

2. The vehicle light of claim 1 further comprising a processor configured to automatically cycle between the two LEDs of the first color and the two LEDs of the second color to active a beam pattern without a beam shift or a change in the beam pattern resulting in a minimal to no change in an illuminated area.

3. The vehicle light of claim 2 wherein the processor is coupled to the two LEDs of the first color and the two LEDs of the second color.

4. The vehicle light of claim 2 further comprising one or more sensors coupled to the processor and configured to determine, measure, and/or detect an amount and/or a density of rain, fog, snow, and/or dust in a surrounding environment and automatically activate and switch between the plurality of first light emitting diodes and the plurality of second light emitting diodes based on the amount or the density.

5. The vehicle light of claim 1 wherein the two LEDs of the first color are positioned symmetrical in the X plane with respect to the two LEDs of the second color.

6. The vehicle light of claim 1 wherein the two LEDs of the first color are positioned symmetrical in the Y plane with respect to the two LEDs of the second color.

7. The vehicle light of claim 1 wherein the two LEDs of the first color are positioned symmetrical in both the X and Y planes with respect to the two LEDs of the second color.

8. A vehicle light comprising:
a printed circuit board;
a plurality of first light emitting diodes mounted to the printed circuit board and configured to emit a white color of light;
a first projection lens configured to receive the white color of light and produce a first specific beam pattern for the white color of light exiting therefrom;
a plurality of second light emitting diodes mounted to the printed circuit board and configured to emit a selective yellow color of light, each of the plurality of second light emitting diodes being positioned adjacent to at least one of the plurality of first light emitting diodes;
a second projection lens configured to receive the selective yellow color of light and produce a second specific beam pattern for the selective yellow color of light exiting therefrom; and
a processor configured to automatically cycle between the first plurality of LEDs and the second plurality of LEDs to active a beam pattern without a beam shift or a change in the beam pattern resulting in a minimal to no change in an illuminated area.

9. The vehicle light of claim 8 wherein the processor is mounted to the printed circuit board.

10. The vehicle light of claim 8 wherein the processor is coupled to the plurality of first light emitting diodes and the plurality of second light emitting diodes.

11. The vehicle light of claim 8 wherein the plurality of first light emitting diodes are positioned symmetrical in the X plane with respect to the plurality of second light emitting diodes.

12. The vehicle light of claim 8 wherein the plurality of first light emitting diodes are positioned symmetrical in the Y plane with respect to the plurality of second light emitting diodes.

13. The vehicle light of claim 8 wherein the plurality of first light emitting diodes are positioned symmetrical in both the X and Y planes with respect to the plurality of second light emitting diodes.

14. The vehicle light of claim 8 further comprising one or more sensors coupled to the processor and configured to determine, measure, and/or detect an amount and/or a density of rain, fog, snow, and/or dust in a surrounding environment and automatically activate and switch between the plurality of first light emitting diodes and the plurality of second light emitting diodes based on the amount or the density.

15. The vehicle light of claim 8 wherein the processor is configured to automatically activate and/or cycle between the plurality of first light emitting diodes and the plurality of second light emitting diodes based on environmental condition data received from the one or more sensors.
